(19) United States
(12) Patent Application Publication
(10) Pub. No.: US 2006/0187867 A1
(43) Pub. Date: Aug. 24, 2006

(54) Method of obtaining and linking positional information to position specific multimedia content

(76) Inventor: Krishna Prasad Panje, Bangalore (IN)

Correspondence Address: Philips Electronics North America Corporation;Corporate Patent Counsel, P O Box 3001, Briarcliff Manor, NY, 10510, US

(21) Appl. No.: 10/541,404

(22) PCT Filed: Nov. 4, 2003
(86) PCT No.: PCT/IB03/05897

§ 371 Date: Jul. 1, 2005

(30) Foreign Application Priority Data
Jan. 13, 2003 (EP) 03075080.6

(51) Int. Cl. H04K 3/00; H04B 7/14; H04J 1/10

(52) U.S. Cl. 370/315; 455/1

(57) ABSTRACT

The present invention relates to a method of obtaining positional information of a mobile phone carrier and linking the positional information to position specific multimedia content, such as photos or audio. The method is performed by detecting the position information of the mobile phone and linking the position information to the position specific multimedia content.

The present invention relates to a method of obtaining positional information of a mobile phone carrier and linking said positional information to position specific multimedia content. The invention further relates to a system for obtaining positional information of a mobile phone carrier and linking said positional information to position specific multimedia content.

When travelling, travellers like to have memories e.g. by taking pictures. After a travel the traveller often ends up having thousands of pictures and it can be a problem to remember where a specific picture was taken. Today it is possible to buy special cameras where a Global Positioning System (GPS) is embedded in the camera and then, when a picture is taken, the geographical location can be embedded in the picture. Later, when the tour is complete, the user can sort the pictures according to their GPS coordinates. Once the coordinate is known, the user manually finds out in which city the picture was taken and even what the name of a photographed monument is, with the help of a map.

EP 0869464 relates to a system for securing a person. The system comprises a portable security device being a mobile phone and a portable video camera. The images recorded by the video camera are sent to an emergency centre via the mobile phone and the system then prevents violence on the person, carrying the equipment, by recording the identity of the aggressor(s) and further ensuring that the aggressor is not able to track down the evidence. The mobile phone is used for determining the position of the security system, whereby the emergency centre personnel can track down the person being aggressed. The document does not describe how position information can be added to multimedia content, such as photos.

The problem is that it is necessary to have either a GPS as a standalone or attached to the camera, which makes the solution very expensive for most users. Another problem is that it is necessary to manually determine e.g. city name or monument name based on the GPS values which also makes the method both very cumbersome and difficult to use for people who are not familiar with the use of high tech devices.

It is an object of the present invention to provide a solution to the above-mentioned problems.

This is obtained by a method of obtaining positional information of a mobile phone carrier and linking said positional information to position specific multimedia content characterized in that the method comprises the steps of:
obtaining the position information of the mobile phone based on a position detection of the mobile phone,
linking the position information to said position specific multimedia content.

The position information could be detected after receiving a request from the mobile phone or it could be included in the request received from the mobile phone.

Thereby the geographical position of the traveller is determined and there is no need for a specific GPS function. Further, by determining the geographical position of a mobile phone, the method can be used by a large number of people since the mobile phone is already a widely accepted and used device. Many mobile phones already have a specific positioning ability, but even if they do not have this, the position can be found by standard positioning techniques. The standard positioning techniques could e.g. be techniques such as the accurate Enhanced-Observed Time Difference (E-OTD) or the less accurate techniques, where the Cell ID in Global System for Mobile Communication (GSM) is obtained or by using Timing Advance TA methods.

A mobile phone carrier having a camera can then, when storing a photo in the camera, link the position of the mobile phone carrier to the photo. The method could e.g. be performed at a web portal, where the web portal receives a request from the mobile phone e.g. via Short Message Service (SMS) or Wireless Application Protocol (WAP). After receiving the request the portal detects the position of the mobile phone e.g. by requesting it from a service provider detecting the position of the mobile phone using the standard positioning techniques. When the position information has been detected, it can be linked to the multimedia content e.g. by ensuring that the multimedia content and the position information share a unique ID.

Similarly, when the user doesn't have any multimedia equipment, then, when the position information of the mobile phone (hence the user) is detected, it can be linked to previously stored multimedia content in the web portal.

The position specific multimedia content could e.g. be a photo taken at the position (either by the user or by a photo maintained or collected by the portal) or an audio recorded at the position e.g. at a sporting event. In the case where the position specific multimedia content is audio, the audio could be recorded by using the microphone in the mobile phone. Alternatively, audio content could be an audio clip, which is pre-recorded and stored by the web portal (for example, sound from a Motor Grand Prix circuit).

In a specific embodiment the method further comprises the step of receiving identification of said position specific multimedia content from the mobile phone carrier. In this case the portal only receives an identification of the position specific multimedia content. The identification could correspond to an identification of a photo stored in an analog or in a digital camera being carried by the mobile phone carrier.

Alternatively, the received identification of the position specific multimedia content could be an identification of multimedia content that has been selected by the mobile phone carrier between a number of identifications of stored position specific multimedia content received from the portal. The number of identifications of stored position specific multimedia content could be obtained from the portal according to the detected position information. This enables a mobile phone carrier, not carrying a multimedia content recorder, to use the prestored position specific multimedia content instead. Further, the stored content could be used as a supplement to the multimedia content recorded by the analog or digital camera as specified above.

In another embodiment the method further comprises the step of receiving position specific multimedia content from the mobile phone carrier. The recorded position specific multimedia content could also be transmitted from the mobile phone to the portal. This could e.g. be done by transmitting a photo from a camera connected to the mobile telephone. In this case the portal can store all multimedia content centrally and the information stored on the camera could be deleted. It is thereby obtained that it is not crucial to avoid deletion of the photos stored in the memory card of e.g. a digital camera, and smaller memory cards could be used. Further, in case the camera gets stolen, the memory card is deleted by accident or the memory card is destroyed, a safety backup is provided at the portal. Further, by storing the information at the portal, other people could get access to the position specific multimedia content by establishing access to the portal using e.g. a password authorized by the mobile phone carrier.

In an embodiment the position specific multimedia content is recorded by a multimedia recording device at said position of the mobile phone carrier. In this case content being unique for the mobile phone carrier such as pictures or sound is recorded and attached with position information. This could e.g. be a picture or sound from a specific situation or person.

In another embodiment the method further comprises the step of receiving properties of said multimedia recording device from the mobile phone carrier.

This could e.g. be according to properties of the camera such as luminous intensity, exposure or lens zoom, which later can be valuable information.

In yet another embodiment the step of detecting the position information of the mobile phone also comprises detecting the magnetic orientation of the mobile phone carrier.

Thereby not only the position but also the orientation of the mobile phone carrier can be obtained and this can be used to establish what the mobile phone carrier is looking at. By establishing this, the name of e.g. a tourist attraction can be obtained and linked to the multimedia content.

In an embodiment the method further comprises the step of sorting the multimedia content according to sorting criterion.

The sorting criterion could e.g. be the geographical position such as country, city or monument name. Further, the criterion could be the properties of the multimedia device as described above. It is thereby obtained that a specific photo can easily be found.

In another embodiment the sorting criterion is based on properties extracted from the position information. By sorting according to position, a travel trail could e.g. be generated.

In yet another embodiment the sorting criterion is selected by the mobile phone carrier and received from the mobile phone. Thereby the sorting could be performed from the mobile phone and the content could e.g. be sorted and presented for e.g. a travel companion or a friend met during a travel.

In a specific embodiment the detection of the position information of the mobile phone is performed periodically after receiving said request from the mobile phone. Thereby the travel trail could be generated and associated with position specific content, without the need for actions performed by the mobile carrier.

The invention further relates to a system for obtaining positional information of a mobile phone carrier and linking said positional information to position specific multimedia content. The system comprises:
means for obtaining the position information of the mobile phone based on a position detection of the mobile phone,
means for linking the detected position information to said position specific multimedia content.

In the following, preferred embodiments of the invention will be described referring to the figures, where

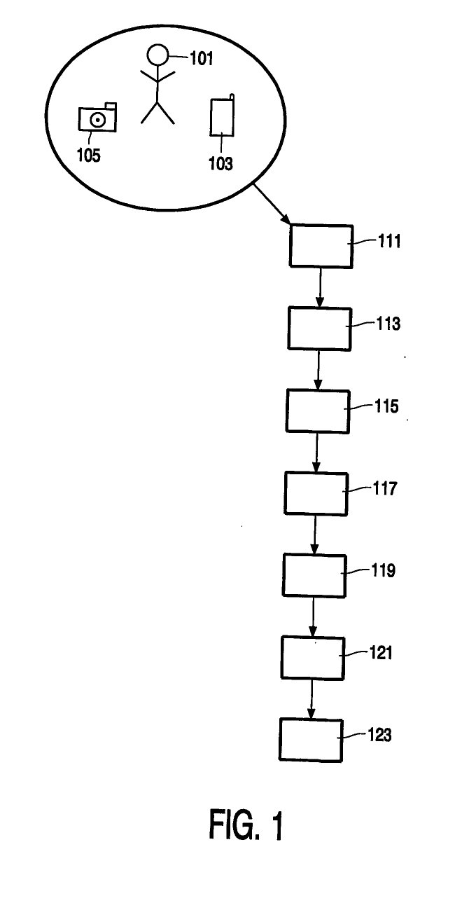

FIG. 1 illustrates an example of the present invention where the multimedia contents are photos recorded by a camera carried by the mobile phone carrier,

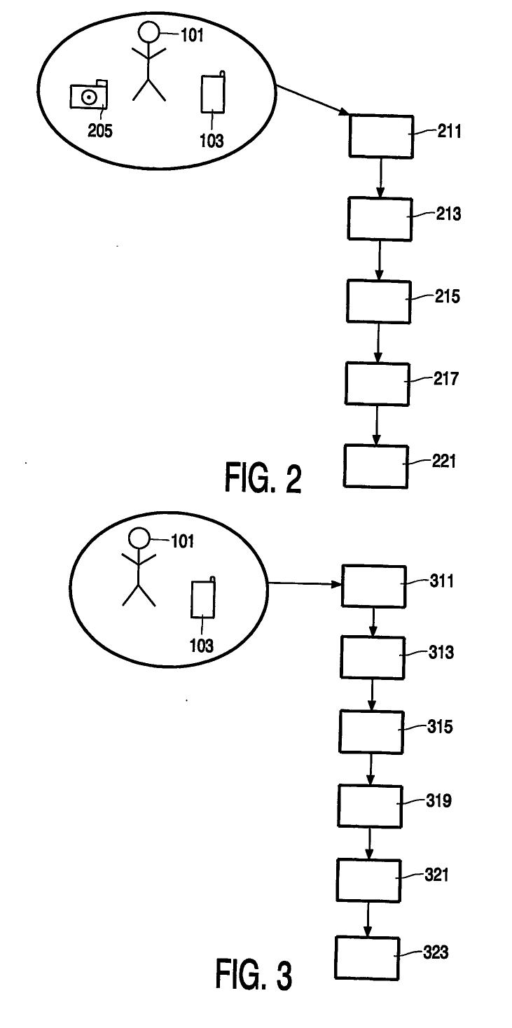

FIG. 2 illustrates an example where the camera comprises communication means for communicating with the mobile phone,

FIG. 3 illustrates an embodiment of the present invention where the mobile phone carrier does not carry a camera.

In FIG. 1 it is illustrated how the positioning using the mobile phone can be performed according to the present invention where the position specific multimedia contents are photos recorded by an analog camera 105 carried by the mobile phone carrier 101.

In 111, access to a WAP portal is established from the mobile phone 103. This could include transmitting personal identification to the WAP portal such as e.g. phone number, country info, e-mail address and/or provider info. After the connection to the WAP portal has been established, the mobile phone carrier can enter data which are to be transmitted to the portal using a WAP client on the mobile phone. First 113 the mobile phone carrier could create a session (S) 113 e.g. as a “New photo session”. Next 115, the mobile phone carrier specifies an ID of the current film role (FRID) in the analog camera 105. This could e.g. be specified with identification parameters such as Role ID 1 for the first role or first session.

A session has now been created and the mobile phone carrier can now start taking photos. When a photo has been shot, the photo identification is sent to the WAP portal via the mobile phone. When e.g. the first photo has been stored in the analog camera, the photo ID (PID) of that photo could be supplied 117 as 1 to the portal via the mobile phone (the number could e.g. be the same as the number of the exposure display counter of the analog camera). Besides the photo ID, the portal could also be supplied with individual attributes of the photo taken, like camera settings and a comment. Further, the mobile phone could also supply the portal with a sound recorded by the phone, such as ambient noise at the place where the photo is shot or a comment made by the mobile phone carrier. Additionally, the mobile phone could provide the portal with the magnetic direction of the mobile phone carrier when shooting the photo, which would make the positioning of the mobile phone even more exact.

The portal has now been informed that a photo has been taken and the position detection (PD) of the mobile phone can be initiated 119. This position detection could be performed using standard positioning methods from which a third party, such as the portal, can request and obtain a position of a specified mobile phone via e.g. the Internet (the positioning method could e.g. be Network Initiated Location Request (NI-LR) using E-OTD and Mobile Originated Location Request). If the mobile phone does not support the accurate positioning techniques described above, another method would be to request the GSM Cell ID from the network operator and then use this ID to request the geographical area covered by that GSM cell from the GSM service provider. This results in a rough estimate, which can still be used to find a specific area in a city and which can be further refined by showing a digital map of the area. The position detection could also comprise establishing further position specific information such as weather conditions based on the time and on the detected position.

After having obtained the detected position (PD) and the photo specific information like the photo ID (PID), the data are linked 121 e.g. by storing (S) the information with a unique common ID at the portal or within the same file. This is performed each time a photo is taken and when a photo session is completed e.g. because a film role is ended or because a vacation has ended. The session is ended (!S) 123 by giving instructions from the mobile phone. A complete photo session has ended comprising a number of photos where each photo is linked with specific information, such as position information and other information as specified above.

In FIG. 2 an example is given where the camera 205 is e.g. a digital camera comprising communication means for communicating with the mobile phone e.g. (IRDA, Bluetooth, USB and RS232) and storage means such as a memory card for storing the photos. In 211, access to a WAP portal is established as described with FIG. 1 and then the mobile phone carrier creates a session (S) 213. After the session has been created, the mobile phone carrier can start taking photos. When a photo has been shot (PS) information indicating this is sent 215 to the WAP portal via the mobile phone. The portal has now been informed that a photo has been taken and the position detection (PD) of the mobile phone can be initiated 217. After having obtained the detected position (PD), the detected position is transmitted from the WAP portal to the camera via the mobile phone and the detected position and the photo are linked e.g. by storing the information with a unique common ID in the memory card of the camera. The detected position can be a HTTP link generated by the portal, which has the positional information and associated information. The PD can also be unique ID generated for that user at that location. This is performed each time a photo is taken and when a photo session is completed because e.g. a vacation has ended. The session is ended (!S) 221 by giving instructions from the mobile phone. A complete photo session has ended and a set of photos is stored in the camera together with a specified position. The information could e.g. be embedded with the photo, this information being an HTTP link to the specified position or an HTTP link to the specified position coupled with position specific information (like audio clip, folk song etc) for each photo. It is an advantage if the HTTP link is embedded to the picture because the content it refers to (a map, a folk song etc) can be downloaded by the user at his convenience.

Now, if the multimedia device has two storing media, then the sorting and copying of photos from one medium to the other can be facilitated by the portal itself. Assume the user has taken photos in the following locations:

1) In Rome, near coliseum

2) In San Marino Grand Prix circuit.

3) Near Venice

If the user gives a request to the portal

Step 1) Sort and copy image from one medium (or session) to the other.

Step 2) Now portal derives the names of the locations from the coordinates where these multimedia recordings (photos) are taken.

Step 3) Now portal throws names of these locations to the user (as SMS or as web page). This may look like this:

1) Rome—coliseum

2) San Marino—GP circuit

3) Venice—Island Murano

Step 4) Now user may ask the portal to copy—San Marino GP recordings from one medium to the other medium.

Step 5) Now the portal may simply prompt the user on the mobile phone display about which photo IDs belong to San Marion GP recordings and the user can simply copy them, without looking at the photograph.

Step 6) Alternatively, the photos can be copied automatically by having a suitable link (IR or Bluetooth) and a program.

In FIG. 3 an embodiment of the present invention is described where the mobile phone carrier does not carry a camera. In 311, access to a WAP portal is established as described in connection with FIG. 1 and then in 313 the mobile phone carrier creates a session (S) from the mobile phone. After the session has been created, the mobile phone carrier can start obtaining position specific photos or audio etc. This is performed by indicating firstly for the portal that a position specific photo should be acquired (AP) 315. The indication could, in an embodiment, comprise a sound recorded by the phone such as ambient noise at the position or a comment made by the mobile phone carrier.

The portal then detects the position (PD) of the mobile phone 317 and in 319 the detected position is used to find a position specific photo. The photo could e.g. be found from a number of photos already stored at the portal together with their position information. Alternatively, the photos could be stored in a third part server connected to the portal via a network, such as the Internet. The photos could also be stored in file formats such as JPEG, EXIF and TIFF and the positional information could be tagged in the file format of the photo. Besides using the position information to find a position specific photo, time information could also be used. A photo that has been taken at the same time or approximately at the same time of the day and of the season could be chosen e.g. ensuring that a night photo is chosen at night and a fall photo is chosen if the mobile phone carrier is traveling during fall. Further, if the magnetic direction of the line of sight of the mobile phone carrier is also sent from the mobile phone to the portal, then it would be possible to determine what object the mobile phone carrier is looking at and use this for obtaining a position specific photo of the object.

After having obtained the detected position (PD) and the position specific photo (FP) or number of photos, either the photos or a link to the photos are stored 321 in a specific area of the portal or the portal could add it to a web page, being maintained by the portal for specific session. The position detection and the obtaining of a position specific photo are performed each time it is requested by the mobile phone carrier. When a photo session is completed e.g. because a vacation or journey has ended, the session is ended (!S) 323 by giving instructions from the mobile phone. A complete photo session has ended comprising a number of position specific photos.

In a practical situation, the embodiment described using FIG. 3 can be used to send a post card, a travel trail or a log to a friend as described below. In the example, the mobile phone carrier uses SMS instead of WAP for communicating with the portal.

It is assumed that the mobile phone carrier is near Niagara Falls. It is evening and the waterfall is lit up. He wants to send a post card of the waterfall/area to his friend in India.
1. The mobile phone carrier sends an SMS to the portal (portal can be a website or a telephone number derived from that). The SMS contains the postal address or e-mail address of the mobile phone carrier's friend (intended post card receiver).
2. The portal initiates the position finding after receiving the SMS by determining the position of the mobile phone from which the SMS was sent.
3. Now the portal searches the tag information embedded in JPEG/EXIF files and stored in its database for coordinates, which closely match with the mobile phone carrier's position and optional time/season etc.
4. Optionally, the portal could maintain digital maps of cities; hence it maintains a database of places against location. So the portal can also sort pictures by the name of the mobile phone carrier's location, if the pictures do not contain the coordinates.
5. Optionally, the portal may send the name of pictures available to the mobile phone carrier as an SMS. This might be the following message:
   ▪ “Please select what you want”
   1. “Morning shot of Niagara spring season”
   2. “Evening shot of Niagara all lit up”
      Assume that the mobile phone carrier selects option 2 and informs the portal.
6. Optionally, the mobile phone carrier can make a call or visit to the portal and leave a message that records the surrounding ambient noise of the waterfall. Or the portal can also have the audio clip stored already similar to the stored photos.
7. Now the portal sends the picture to the receiver, which could be customized as per the mobile phone carrier's location/time/season or at least one of them. Alternatively, the portal could send a link to the picture. The portal could also send the recorded ambient noise as a wav or mp3 file.
8. Alternatively, the portal may inform its partner portal in the receiver's country (in this case it is India) to send the respective picture to the mobile phone carrier's friend. The picture can be delivered in paper or as a CD with audio clip etc.
9. Optionally, the portal may record and publish all the location specific content as a web page, or it can send the user's travel trail CD (with multimedia content of course) to the receiver (user's friend in this case), with the help of its partner portal in the receiver's country.

Now three embodiments have been described where a position of a mobile phone carrier is detected and where the position is linked to position specific multimedia content such as position specific photos and or position specific audio. Additionally, it has been described how position specific photos could be linked with properties of the camera when shooting the picture. The linked information could be stored in the described embodiments, either at the portal or in the memory card of the camera. In a further embodiment, the information could be stored in the mobile phone.

After storing the information, a user can access the information and use the additional data to sort the photos according to the additional data e.g. sorting per location, sorting per camera property or sorting per magnetic direction. The sorted information can then either be mailed to the mobile phone carrier's home e-mail address or to a friend's e-mail address, which has been specified by the mobile phone carrier. Further, the sorting could be used for e.g. copying the photos into two memory cards, one memory card could comprise photos from Germany and another photos from India. Further, by using time information and position, a tour map can be generated showing how and when the traveler or mobile phone carrier travels from destination to destination.

In other embodiments the present invention could be used for generating a travel trail or a virtual picture album when the traveller has got no camera; or if the camera is forgotten, the travel trail could then automatically be made known to his friends or relatives by a web page update.

Further, the invention could be used by tourists to send picture post cards to their family members and friends when they are near a historic monument, a nature spot etc. Then travellers can send their vacation travel trails (with text and multimedia content) to their friends/relatives without having a multimedia-recording device such as camera. Instead, the thousands of photographs of famous monuments already taken and available (digitally as well as in paper) can be used. A person standing near Taj Mahal need not search for a post card there to send that to his friend. Instead one of the thousands of photographs can be used. Similarly, location specific multimedia contents like folk songs etc could be sent.

This solves the problems of sending such pictures as paper post cards especially from a foreign country which can be expensive (postage stamps, envelope etc). Further, finding a right picture that reflects the traveller's situation (time, season of the year and ambient condition) is pretty tough. Also, sending a JPEG/EXIF file as an e-mail is also a problem because the traveller has to locate an internet café, pay for browsing and selecting a picture etc. Even if he browses using the mobile phone it is also expensive and time consuming. Further, sending an image doesn't include ambient noise, atmospheric information, local folk music and not even time information.

1. A method of obtaining positional information of a mobile phone carrier and linking said positional information to position specific multimedia content, the method comprises the steps of:
obtaining the position information of the mobile phone based on a position detection of the mobile phone,
linking the position information to said position specific multimedia content.

2. A method according to claim 1, wherein the method further comprises the step of receiving identification of said position specific multimedia content from the mobile phone carrier.

3. A method according to claim 1, wherein the method further comprises the step of receiving position specific multimedia content from the mobile phone carrier.

4. A method according to any of the claims 1-3, wherein the position specific multimedia content is recorded by a multimedia recording device at said position of the mobile phone carrier.

5. A method according to claim 4, wherein the method further comprises the step of receiving properties of said multimedia recording device from the mobile phone carrier.

6. A method according to any of the claims 1-5, wherein the step of detecting the position information of the mobile phone also comprises detecting the magnetic orientation of the mobile phone carrier.

7. A method according to any of the claims 1-6, wherein the method further comprises the step of sorting the multimedia content according to a sorting criterion.

8. A method according to claim 7, wherein the sorting criterion is based on properties extracted from the position information.

9. A method according to claim 7-8, wherein the sorting criterion is selected by the mobile phone carrier and received from the mobile phone.

10. A method according to claim 1-9, wherein the detection of the position information of the mobile phone is performed periodically after receiving said request from the mobile phone.

11. A system for obtaining positional information of a mobile phone carrier and linking said positional information to position specific multimedia content, the system comprises:
means for obtaining the position information of the mobile phone based on a position detection of said mobile phone,
means for linking the detected position information to said position specific multimedia content.
